(19) United States
(12) Patent Application Publication
(10) Pub. No.: US 2005/0052088 A1
(43) Pub. Date: Mar. 10, 2005

(54) Shaft, bearing and motor

(76) Inventors: Kazuhiko Kakegawa, Chiisagata-gun (JP); Morinobu Endo, Suzaka-shi (JP)

Correspondence Address: BIRCH STEWART KOLASCH & BIRCH, PO BOX 747, FALLS CHURCH, VA, 22040-0747, US

(21) Appl. No.: 10/603,922

(22) Filed: Jun. 26, 2003

(30) Foreign Application Priority Data
Jun. 28, 2002 (JP) 2002-190640

(51) Int. Cl. H02K 5/16

(52) U.S. Cl. 310/90

(57) ABSTRACT

The shaft and the bearing are capable of reducing vibration and noise of a motor. The shaft comprises: a shaft proper; and a sliding section provided to the shaft proper, the sliding section including carbon nano fibers or carbon nano tubes. On the other hand, the bearing comprises: a bearing proper; and a sliding section provided to the bearing proper, the sliding section including carbon nano fibers or carbon nano tubes.

### BACKGROUND OF THE INVENTION

The present invention relates to a shaft, a bearing and a motor having the shaft and/or the bearing.

The motor of the present invention is mainly used for, for example, a spindle motor for a magnetic disk drive unit, a spindle motor for an optical disk drive unit, a fan motor, a polygon scanner motor, which should be capable of precisely operating, rotating at high speed, having a long span of life and reducing vibration and noise.

Conventionally, the motors for said use have bearings, e.g., slide bearings, liquid bearings, ball bearings.

These days, the motors are often driven at high speed, e.g., 10,000 rpm or more. For example, the spindle motor for driving magnetic disks or optical disks is operated at rotational speed of 20,000 rpm; the polygon scanner motor is operated at rotational speed of 40,000 rpm. And, extending their span of lives and precise operation are required. Further, reducing vibration and noise are also required. However, the conventional ball bearings and slide bearings cannot satisfy the requests of high speed motors.

The conventional slide bearing contacts and rotatably holds a shaft. Therefore, friction between the both increased, and vibration and noise of the motors are also increased. In the case of using a lubricating oil, heat caused by the frictional resistance deteriorates the oil, an oil film is broken and the oil is spread. So, the heat fuses the shaft and the bearing together.

In the case of using no lubricating oil, heat generation, vibration and noise must be further increased, so that the fusion is apt to occur.

In the conventional liquid bearing, a shaft is rotated without contacting a bearing at a regular rotational speed, but the shaft must contact the bearing when the rotation is started and stopped. Therefore, the liquid bearing has the problems as well as the conventional slide bearing.

### SUMMARY OF THE INVENTION

The present invention has been invented so as to solve the problems of the conventional bearings.

A first object of the present invention is to provide a shaft capable of reducing vibration and noise.

A second object of the present invention is to provide a bearing capable of reducing vibration and noise.

A third object of the present invention is to provide a motor capable of reducing vibration and noise during operation.

To achieve the objects, the present invention has following structures.

Namely, the shaft of the present invention comprises:

a shaft proper; and
a sliding section being provided to the shaft proper, the sliding section including carbon nano fibers or carbon nano tubes.

In the shaft, the sliding section may be an outermost layer of the shaft proper, which includes a metal and carbon nano fibers or carbon nano tubes.

In the shaft, the sliding section may be a circular belt-shaped section partially formed in an outermost layer of the shaft proper.

The bearing of the present invention comprises:
a bearing proper; and
a sliding section being provided to the bearing proper, the sliding section including carbon nano fibers or carbon nano tubes.

In the bearing, the sliding section is made of a sintered metal including carbon nano fibers or carbon nano tubes.

In the bearing, the sliding section may be made of synthetic resin including carbon nano fibers or carbon nano tubes.

In the bearing, the sliding section may be made of a ceramic including carbon nano fibers or carbon nano tubes.

In the bearing, the sliding section may be an outermost layer of the bearing proper, which includes a metal and carbon nano fibers or carbon nano tubes.

In the bearing, the sliding section may be a circular belt-shaped section partially formed in an outermost layer of the bearing proper.

The motor of the present invention has a rotor shaft, which comprises a sliding section including carbon nano fibes or carbon nano tubes.

Another motor of the present invention a bearing for a rotor shaft, and the bearing comprises a sliding section including carbon nano fibers or carbon nano tubes.

In the present invention, the carbon nano fibers or carbon nano tubes are included in the sliding section of the shaft and/or the bearing, so that friction, vibration and noise can be reduced. Namely, the motor capable of reducing vibration and noise can be realized. Since the carbon nano fibers and the carbon nano tubes have high heat conductivity, heat generated in the sliding section can be restricted so that fusion of the shaft and the bearing can be prevented. Enough lubricating property can be gained without using lubricant. If lubricant is used, the lubricating property can be further improved, so that an oil film can be maintained without spreading oil. Therefore, the friction, the vibration and the noise can be further reduced.

### BRIEF DESCRIPTION OF THE DRAWINGS

Embodiments of the present invention will now be described by way of examples and with reference to the accompanying drawings, in which:

FIG. 1 is a sectional view of a polygon scanner motor of an embodiment of the present invention; and

FIG. 2 is an explanation view of a sliding member including carbon nano fibers, which is formed by plating.

### DETAILED DESCRIPTION OF THE EMBODIMENTS

Preferred embodiments of the present invention will now be described in detail with reference to the accompanying drawings.

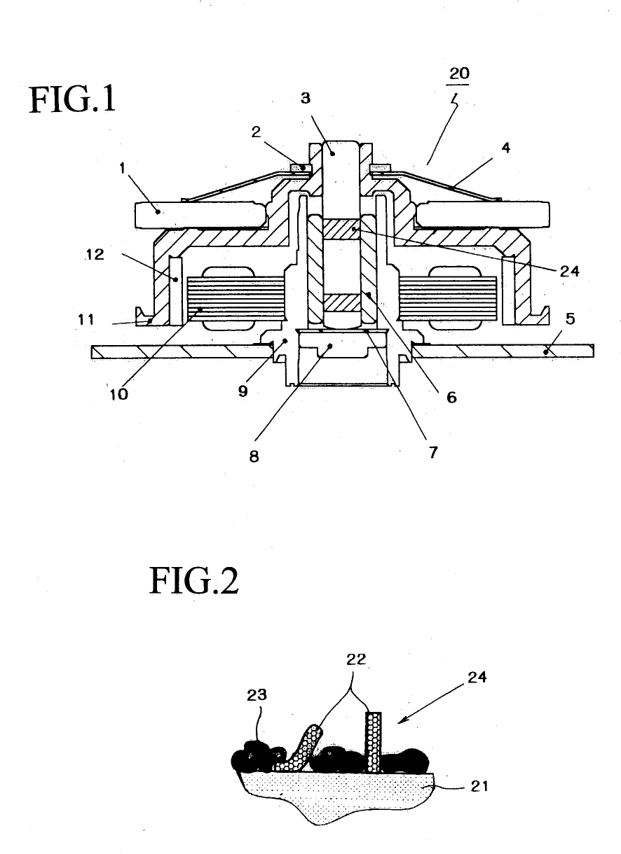

A polygon scanner motor of an embodiment of the present invention is shown in FIG. 1.

The polygon scanner motor 20 has a rotor cup 11, which is fixed to a rotor shaft 3 and rotated together with the rotor shaft 3. A ring magnet 12 is fixed on an inner face of the rotor cup 11.

The rotor shaft 3 is rotatably held by a cylindrical bearing 6 and a thrust bearing 7, which are provided in a housing 9 vertically extended from a circuit board 5. The thrust bearing 7 is provided on an upper face of an end cover 8. The end cover 8 is screwed with the housing 9.

A stator core 10 is fixed on an outer circumferential face of the housing 9. Lines are wound on the stator core 10 so as to form coils.

A polygon mirror 1 is fixed to the rotor cup 11. The polygon mirror 1 is pressed and held by a mirror spring 4. A movement of the mirror spring 4 in the axial direction is limited by a snap ring 2.

Circuits for driving the motor are formed on the circuit board 5. The polygon mirror 1 is rotated at high rotational speed together with the rotor cup 11.

The polygon scanner motor 20 has a known structure, and its structure is not limited. Further, the motor of the present invention is not limited to polygon scanner motors.

In the present embodiment, the rotor shaft 3 and the bearings 6 and 7 have features.

Namely, sliding sections of the rotor shaft 3 and the bearings 6 and 7 include carbon fibers (carbon nano fibers and/or carbon nano tubes).

In the following embodiments, known carbon nano fibers and carbon nano tubes are employed as carbon fibers.

The carbon fibers are included in the sliding sections of the rotor shaft 3, etc.

One layer or a plurality of layers of the carbon fibers are used. One end or both ends of each layer may be closed by a fullerene-shaped cup or cups.

Note that, the carbon nano fiber means a carbon nano tube whose length is at least 100 times greater than a diameter.

Diameters of the carbon fibers used in the embodiments are several nanometers (nm) to several hundred nanometers (nm), e.g., 300 nm, at the largest.

In the present embodiments, as an example, the carbon nano fibers or the carbon nano tubes are added to materials of the rotor shaft 3 and the bearings 6 and 7.

For example, a sintered metal may be employed as the material of each member. The sintered metal is made by molding metal powders, e.g., iron powders, copper powders, and baking the molded body. The metal powders are mixed with the carbon nano fibers or the carbon nano tubes. By baking the molded body, a porous shaft or bearing can be produced. In the case of the bearing, oil may be impregnated in fine holes of the porous bearing. Even if no oil is impregnated, the carbon fibers have sliding ability so that the bearing has enough lubricating property.

Coefficient of the carbon fibers is very small. By adding the carbon fibers to the shaft and the bearings, friction therebetween can be reduced, so that vibration and noise can be reduced. Further, the carbon fibers have high heat conductivity, so generating heat can be limited.

In the case of employing the sliding sections impregnating oil, friction can be further reduced and generating heat can be further limited. Therefore, spreading lubricating oil can be securely prevented, oil films can be properly formed, and the rotor shaft can be rotated smoothly. Vibration and noise can be further reduced.

Synthetic resin may be employed as the material of the bearings. Fluoric resin having, whose coefficient of friction is small, is usually employed. By including the carbon fibers in the resin, friction can be reduced, so that vibration and noise can be reduced.

Ceramics may be employed as the material of the bearings. Since ceramics are hard, abrasion can be highly limited. By including the carbon fibers in a ceramic, abrasion and friction can be reduced, and vibration and noise can be reduced.

Amount of the carbon fibers is not limited. According to our experiments, shafts and bearings, whose content of the carbon fibers is about 10 wt %, have enough lubricating property.

Since carbon nano fibers and carbon nano tubes are expensive materials, manufacturing cost will be high if they are wholly included in the shaft 3 and the bearings 6 and 7.

In the present embodiment, expensive carbon fibers are provided to only the sliding sections of the shaft and the bearings, so total amount of them can be reduced. Namely, manufacturing cost of the shaft and the bearings can be reduced.

A preferred method of forming the sliding sections including the carbon fibers in an outer circumferential face of the shaft 3, an inner circumferential face of the cylindrical bearing 6 and an upper face of a plate-shaped thrust bearing 7 will be explained.

The sliding sections are formed by dispersal plating. Namely, carbon nano fibers or carbon nano tubes are mixed with a plating solution, and a plating metal enclosing the carbon nano fibers or the carbon nano tubes precipitates on the shaft proper or the bearing proper. By the dispersal plating, the sliding sections including the carbon nano fibers or the carbon nano tubes are formed on the shaft proper or the bearing proper.

As shown in FIG. 2, parts of carbon fibers 22 in the sliding section (layer) 24 are held and fixed, by the plating metal 32, on the shaft proper (or the bearing proper) 21.

The dispersal plating is one of means for fixing the carbon nano fibers 22 or the carbon nano tubes 22. In another case, carbon nano fibers or carbon nano tubes, which have been floated in a gas, may be fixed to the shaft proper or the bearing proper 21 by thermal spraying. Namely, fixing means is not limited.

The metal 23 and the carbon fibers 22 are mixed in the sliding section (layer) 24.

The sliding sections 24 may be formed in the whole faces of the shaft and the bearings. As shown in FIG. 1, the belt-shaped sliding sections 24 may be partially formed in the shaft 3 and the bearing 6.

The carbon nano fibers and the carbon nano tubes have high tensile strength in the axial directions thereof, further they have enough flexibility. Even if the carbon nano fibers or the carbon nano tubes are projected from the sliding section 24 (see FIG. 2), they can be easily bent on the surface of the sliding section 24 by load, which is applied when the shaft sliding and rotating on the bearing. With this action, concentrating load to front ends of the carbon nano fibers or the carbon nano tubes can be prevented. Further, lubricating property can be improved.

The invention may be embodied in other specific forms without departing from the spirit or essential characteristics thereof. The present embodiments are therefore to be considered in all respects as illustrative and not restrictive, the scope of the invention being indicated by the appended claims rather than by the foregoing description and all changes which come within the meaning and range of equivalency of the claims are therefore intended to be embraced therein.

1. A shaft,
comprising:
a shaft proper; and
a sliding section being provided to said shaft proper, said sliding section including carbon nano fibers.

2. The shaft according to claim 1,
wherein said sliding section is an outermost layer of said shaft proper, which includes a metal and carbon nano fibers.

3. The shaft according to claim 1,
wherein said sliding section is a circular belt-shaped section partially formed in an outermost layer of said shaft proper.

4. A shaft,
comprising:
a shaft proper; and
a sliding section being provided to said shaft proper, said sliding section including carbon nano tubes.

5. The shaft according to claim 4,
wherein said sliding section is an outermost layer of said shaft proper, which includes a metal and carbon nano tubes.

6. The shaft according to claim 4,
wherein said sliding section is a circular belt-shaped section partially formed in an outermost layer of said shaft proper.

7. A bearing,
comprising:
a bearing proper; and
a sliding section being provided to said bearing proper, said sliding section including carbon nano fibers.

8. The bearing according to claim 7,
wherein said sliding section is made of a sintered metal including carbon nano fibers.

9. The bearing according to claim 7,
wherein said sliding section is made of synthetic resin including carbon nano fibers.

10. The bearing according to claim 7,
wherein said sliding section is made of a ceramic including carbon nano fibers.

11. The bearing according to claim 7,
wherein said sliding section is an outermost layer of said bearing proper, which includes a metal and carbon nano fibers.

12. The bearing according to claim 7,
wherein said sliding section is a circular belt-shaped section partially formed in an outermost layer of said bearing proper.

13. A bearing,
comprising:
a bearing proper; and
a sliding section being provided to said bearing proper, said sliding section including carbon nano tubes.

14. The bearing according to claim 13,
wherein said sliding section is made of a sintered metal including carbon nano tubes.

15. The bearing according to claim 13,
wherein said sliding section is made of synthetic resin including carbon nano tubes.

16. The bearing according to claim 13,
wherein said sliding section is made of a ceramic including carbon nano tubes.

17. The bearing according to claim 13,
wherein said sliding section is an outermost layer of said bearing proper, which includes a metal and carbon nano tubes.

18. The bearing according to claim 13,
wherein said sliding section is a circular belt-shaped section partially formed in an outermost layer of said bearing proper.

19. A motor having a rotor shaft, which comprises
a sliding section including carbon nano fibers.

20. A motor having a rotor shaft, which comprises
a sliding section including carbon nano tubes.

21. A motor having a bearing for a rotor shaft,
wherein said bearing comprises a sliding section including carbon nano fibers.

22. A motor having a bearing for a rotor shaft,
wherein said bearing comprises a sliding section including carbon nano tubes.
